(19) United States
(12) Patent Application Publication
(10) Pub. No.: US 2007/0136372 A1
(43) Pub. Date: Jun. 14, 2007

(54) Methods of quality of service management and supporting apparatus and readable medium

(76) Inventors: Lee M. Proctor, Cary, IL (US); Jay P. Jayapalan, Buffalo Grove, IL (US); John M. Harris, Chicago, IL (US)

Correspondence Address: MOTOROLA, INC., 1303 EAST ALGONQUIN ROAD, IL01/3RD, SCHAUMBURG, IL, 60196, US

(21) Appl. No.: 11/299,598

(22) Filed: Dec. 12, 2005

(51) Int. Cl. G06F 17/00

(52) U.S. Cl. 707/104.1

(57) ABSTRACT

A change in user interest level of a user application of a client device in communication with a network infrastructure at a first quality of service level is assessed (306). In response, the quality of service associated with the user application is dynamically changed (308) to a second quality of service level, while keeping the user application active, based, at least in part, on the change in user interest level of the user application.

### TECHNICAL FIELD

This invention relates generally to quality of service management on a network.

### BACKGROUND

Typically, a user application has a fixed desired level of quality of service, such as data priorities. When a user is using multiple applications, however, this fixed quality of service as assigned to these applications may not be appropriate for the current main activity of the user. For example, a user may be simultaneously using multiple high bandwidth applications, which is becoming more typical, such as a video streaming application, a file download, and web browsing. The user, under these circumstances, often has a severely limited transport connection to the Internet, especially on a cellular network.

Current priority schemes will generally prioritize the flows associated with the applications in the following order of streaming, browsing, and downloading. The user, though, may move the Internet browser window over the streaming window, which usually indicates that the user has expressed a temporary desire to concentrate on browsing rather than watching the video. In cases such as this, the aforementioned fixed flow priority scheme is misplaced and inefficient.

### BRIEF DESCRIPTION OF THE DRAWINGS

The accompanying figures, where like reference numerals refer to identical or functionally similar elements throughout the separate views and which together with the detailed description below are incorporated in and from part of the specification, serve to further illustrate various embodiments and to explain various principles and advantages all in accordance with the present invention.

FIG. 1 comprises a block diagram of an exemplary wireless communications system suitable for various embodiments of the invention;

FIG. 2 comprises a block diagram of a client device according to various embodiments of the invention;

FIG. 3 comprises a flow chart diagram of a management process according to an embodiment of the invention; and

FIG. 4 comprises a flow chart diagram of a detection process according to an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, a change in user interest level of a user application of a client device in communication with a network infrastructure at a first quality of service level is assessed. In response, the quality of service associated with the user application is dynamically changed to a second quality of service level, while keeping the user application active, based, at least in part, on the change in user interest level of the user application.

In a specific embodiment, prior to the assessment of the change in user interest level, the user application is initiated at the first quality of service level. For another embodiment, the user application is a video stream such that the first quality of service level is associated with video portion of the video stream and the second quality of service level is associated with the audio portion of the video stream. According to one embodiment, the first quality of service level is provided from the client device to the network infrastructure via a first quality of service profile identifier. In an embodiment, the second quality of service level is provided from the client device to the network infrastructure via a second quality of service profile identifier.

For one embodiment, a quality of service associated with a second user application is further dynamically changed based, at least in part, on the change in user interest level of the user application. Also in various embodiments, a quality of service of another user who is in communication with the network infrastructure and/or a user of the user application is dynamically changed based, at least in part, on the change in user interest level of the user application.

According to various embodiments, at least one user application of a client device communicating through a network infrastructure is tracked. A change in user interest level of the user application(s) is detected to provide at least one detected change. An indication of the detected change is sent to the network infrastructure, wherein a quality of service associated with the user application(s) is dynamically changed based, at least in part, on the detected change. In one specific embodiment, the indication further includes a request to change the current quality of service of the user application(s) based, at least in part, on the detected change.

According to various embodiments, an apparatus is further provided with a controller circuit that tracks at least one user application in a client device in communication with a network infrastructure and detects a change in user interest level of the user application(s) in order to provide at least one detected change. Moreover, a transceiver coupled to the controller circuit is included to send an indication of the at least one detected change to the network infrastructure, wherein a quality of service associated with the user application(s) is/are dynamically changed based, at least in part, on the at least one detected change. For a particular embodiment, the controller circuit further sends a request to change a current quality of service based, at least in part, on the at least one detected change.

According to various embodiments, a computer-readable medium having thereon computer-executable instructions is further included, which tracks at least one user application in a client device in communication with a network infrastructure, detects a change in user interest level of the at least one user application to provide at least one detected change, and sends an indication of the at least one detected change to the network infrastructure, wherein a quality of service associated with the at least one user application is dynamically changed based, at least in part, on the at least one detected change.

According to various embodiments, the assessment of the change in user level of the user application includes a user specified switch of priority of at least the first user application, a second application at the client device being initiated, a triggered mute function in the client device, a triggered energy conservation function in the client device, a detection of a user of the client device being away from the client device, a screensaver being activated, a backlight being extinguished, an actuator being triggered in a user chair, a detection by a camera of a user being away, an expiration of an inactivity timer, a short range wireless connection being lost, a user modification of a numerical priority associated with the user application, a user adjustment of a slider on a window, a detection of occluding of a window associated with the user application, a change in audio volume at the client device, a triggered download of a web browser plug-in, a triggered user of a web browser plug-in, and/or a detection of presence state of at least one user of the client device.

In various embodiments, dynamic changes in the quality of service to the client device includes, but is not limited to, a dedication of resources to a higher priority user activity, a reduction of resources for a user activity that has been temporarily suspended, a reduction of resources for a user activity that has been de-prioritized, a change in data flow priority, a change in user priority, a change in an application priority, a change in latency, a change in jitter characteristics, a change in frame erasure rate, a change in bit error rate, a change in power control setting, a change in number of resources assigned to data flow of the user application, a change in modulation rate, a change in modulation type, a change in encoding rate, a change in speech encoding rate, a change in video encoding rate, a change in encoding type, a change in speech encoding type, and/or a change in video encoding type.

According to various embodiments, at least one user application in a client device in communication with a network infrastructure is tracked. A change in user interest level of the user application(s) is detected to provide at least one detected change. An indication of the detected change is sent to the network infrastructure, wherein a quality of service associated with the user application(s) is dynamically changed based, at least in part, on the detected change.

Through the embodiments of various teachings, a more intelligent flow priority arrangement has been provided that, among other things, considers the user interest of the client device, instead of following the predefined priority flows of the user applications. As a result, the flow priorities of the user applications match more closely to the current priorities desired by the user instead of the system configurations. This can be especially important when the bandwidth resources are limited, such as in the case of wireless network.

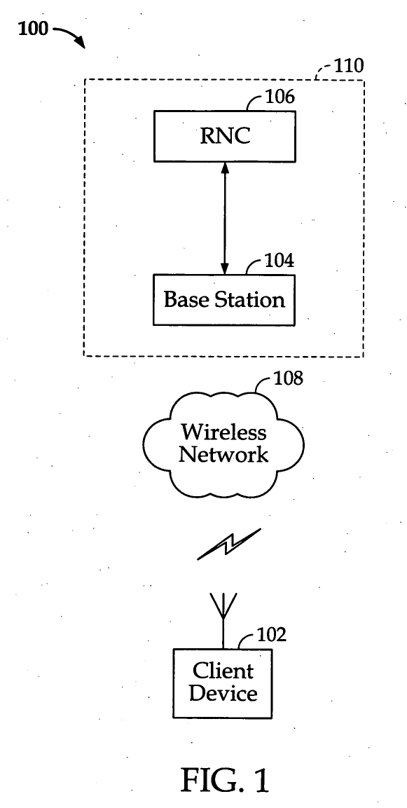

Referring now to the drawings, and in particular to FIG. 1, for purposes of providing an illustrative but non-exhaustive example to facilitate this description, a specific operational paradigm using a wireless communication network is shown and indicated generally at 100. Those skilled in the art, however, will recognize and appreciate that the specifics of this illustrative example are not specifics of the invention itself and that the teachings set forth herein are applicable in a variety of alternative settings. For example, since the various teachings are not platform dependent, they can be applied to any communication network that includes different types of data transmission. Thus, any digital broadcast services or digital satellite services may also applicable. These various platforms and network implementations are, as a result, within the scope of the invention, and various embodiments for these multiple implementations are readily understood and appreciated by one skilled in the art.

Pursuant to this example, a client device 102 communicates with a base station (“BS”) 104 that is operably coupled to a radio network controller (“RNC”) 106 via a wireless network 108. As commonly known in the art, the RNC 106 typically controls multiple BSs 104 (one shown) for data transmission between the client device 102 and the serving BS 104. In this example, typical of a general communication network, the client device 102 sends requests and/or data to the serving BS 104, which, in turn, forwards the requests and/or data to the RNC for processing.

The BS 104 and the RNC 106, as shown, cooperatively route data to multiple client devices 102 (one shown), but depending upon the system, the network may include other components with different arrangement of these components. Thus, the communication system 100 shown is only one of many typical exemplary structures of a cellular communication network that is suitable for use with various described embodiments. Moreover, the RNC 106 along with the BS 104 will herein be referred to as a network infrastructure 110 to emphasize that the data exchange may include communications with either or both the RNC and the BS, depending upon the configuration of the system.

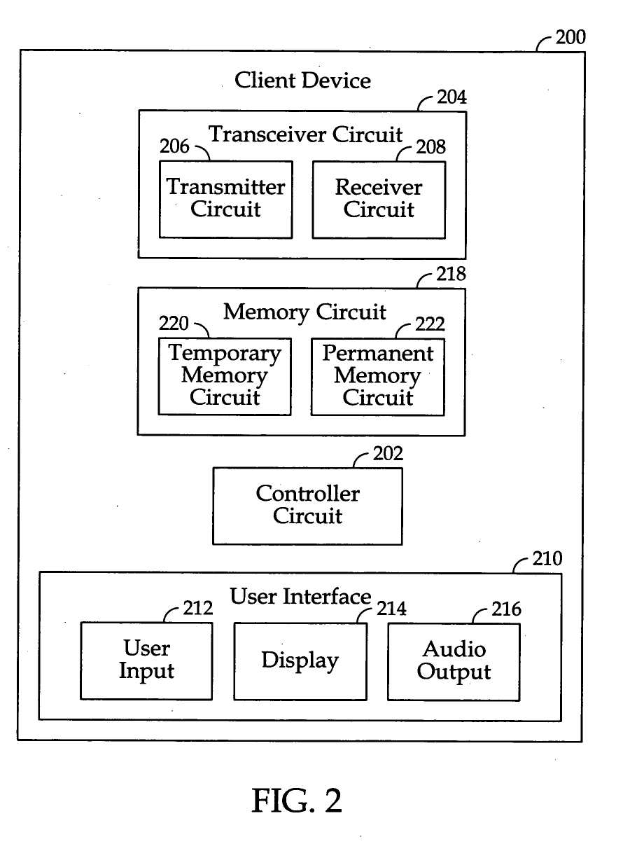

Turning now to FIG. 2, a block diagram of a client device according to various embodiments is shown and indicated generally at 200. Please note that as readily appreciated by one skilled in the art, the circuits and the arrangement of these circuits shown are only given as one of many configurations and circuitry topologies available, and these various alternative embodiments, although not shown, are readily appreciated by a skilled artisan. Thus, these alternative embodiments are within the scope of the various teachings described. It is further assumed that these circuits are coupled or connected to each other in the block diagram. Moreover, since the client device shown is a partial view of circuitry topology of a general communication device, the client device 200 shown does not necessarily include all of the components required of a typical communication device. As such, it should be understood that the various teachings may include other circuit components that may not be shown but are well known to one skilled in the art. Moreover, “circuit” refers to hardware, firmware, and/or software, which may be used to implement any type of executable logic and/or instructions. Thus, these various embodiments of the circuit are contemplated and are all within the scope of the various teachings described.

A dynamic change in the quality of service association with a user application of the client device 200 may be triggered for multiple reasons. Specifically, a controller circuit 202 is included that tracks at least one user application in a client device in communication with a network infrastructure and detects a change in user interest level of the at least one user application to provide at least one detected change. A transceiver 204, which is coupled to the controller circuit 202, sends an indication of the at least one detected change to the network infrastructure, wherein a quality of service associated with the at least one user application is dynamically changed based, at least in part, on the at least one detected change. As typically found in a transceiver, both a transmitter circuit 206 and a receiver circuit 208 are also provided.

The one or more detected change may include, according to various embodiments, a user specified switch of priority of at least the first user application, initiating of a second application at the client device, a triggered mute function in the client device, a triggered energy conservation function in the client device, a detection of a user of the client device being away from the client device, a screensaver being activated, a backlight being extinguished, an actuator being triggered in a user chair, a detection by a camera of a user being away, an expiration of an inactivity timer, a short range wireless connection being lost, a user modification of a numerical priority associated with the user application, a user adjustment of a slider on a window, a detection of occluding of a window associated with the user application, a change in audio volume at the client device, a triggered download of a web browser plug-in, a triggered user of a web browser plug-in, and a detection of presence state of at least one user of the client device.

Moreover, depending upon the communications system, the quality of service associated with the user application may be dynamically changed as a dedication of resources to a higher priority user activity, a reduction of resources for a user activity that has been temporarily suspended, a reduction of resources for a user activity that has been de-prioritized, a change in data flow priority, a change in user priority, a change in an application priority, a change in latency, a change in jitter characteristics, a change in frame erasure rate, a change in bit error rate, a change in power control setting, a change in number of resources assigned to data flow of the user application, a change in modulation rate, a change in modulation type, a change in encoding rate, a change in speech encoding rate, a change in video encoding rate, a change in encoding type, a change in speech encoding type, and/or a change in video encoding type.

A user interface 210 is also provided, which includes a user input 212, a display 214, and an audio output 216. In various embodiments, a memory circuit 218 is also included along with a temporary memory circuit 220 and a permanent memory circuit 222 for storing and maintaining needed predefined condition(s) for triggering the detection of the change in user interest level. Moreover, the memory circuit 218 can also be used as a computer-readable medium to store the computer-executable instructions implemented with the various embodiments of the invention.

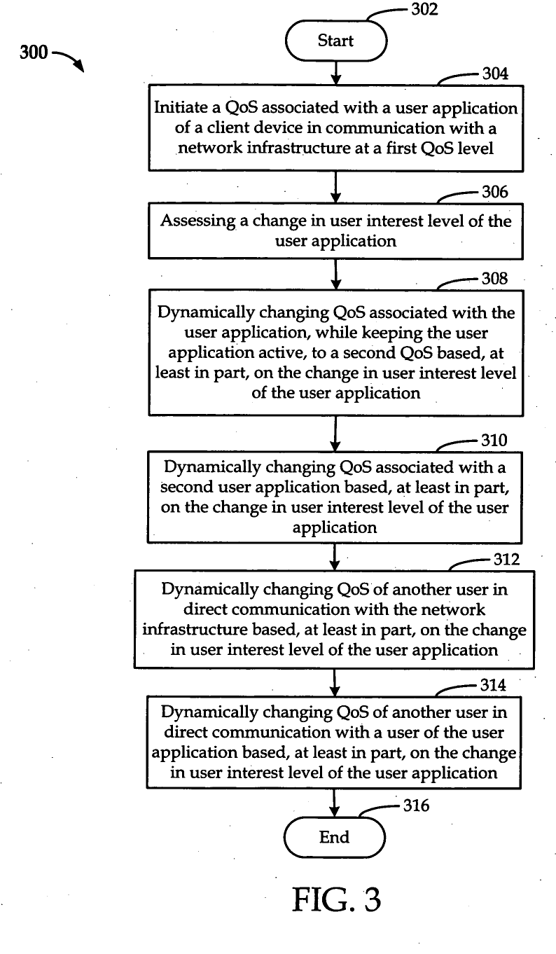

Turning now to FIG. 3, a flow chart diagram of a management process according to various embodiments of the invention is shown and indicated generally at 300. Although the process shown is preferably implemented at the network level, there may be other implementations better suited for other components in the communication system. For example, these processes, as shown, can be implemented fully or partially at either the client device 102 or network 110. Thus, as a skilled artisan would readily appreciate, the flow diagram may be altered according to these different implementations.

And as such, other embodiments of the management process are contemplated and are within the scope of he various teachings shown. Moreover, as one skilled in the art would readily appreciate, any of the processes shown can be altered in multiple ways to achieve the same functions and results of the various teachings described. As a result, these processes shown are one exemplary embodiment of multiple embodiment variations that may not be specifically shown. These other embodiments, however, are within the scope of the various teachings described.

In this particular example shown, the process starts 302 with an initiation 304 of a quality of service that is associated with a user application of a client device in communication with a network infrastructure at a first quality of service level. A change in the user interest level of the user application is then assessed 306, and in response, the quality of service associated with the user application is then dynamically changed 308 to a second quality of service, while keeping the user application active, based, at least in part, on the change in user interest level of the user application. In other specific embodiments, the quality of service associated with a second user application is also dynamically changed 310 based, at least in part, on this change in user interest level of the user application.

As an example, if the user switched an Internet browser window on top of a previous window that was streaming video data, in this case, the user application of the streaming video data may be changed to a lower priority flow while the second user application of the Internet browser window is also changed to a higher priority flow. This is, of course, one of the many examples of how the various teachings can be used. Moreover, the quality of service, in various embodiments, relates to the data delivery, transport, and/or infrastructure of the application. The application, itself, is still controlled by the operating system.

In another embodiment, specifically in the case of when the user application may affect another user communicating through the network infrastructure, the quality of service of this other user may also be dynamically changed 312. Anther scenario is when a user of the user application is in direct communication with another user via the user application, the quality of service of this other user may also be dynamically changed 314 in addition to the user application.

The process, as shown in this embodiment, ends 316 at this point. Of course, there are practically unlimited ways to implement management of quality of service of the user application according to user interest level of the user application for creating a more efficient delegation of network resources. For example, in a push to talk application, one way to adjust the quality of service is that when a first user mutes, the quality of service of the data stream to a second user communicating with the first user can be reduced. Since one skilled in the art can readily appreciate these various implementations, multiple embodiments are included even if they have not been specifically shown.

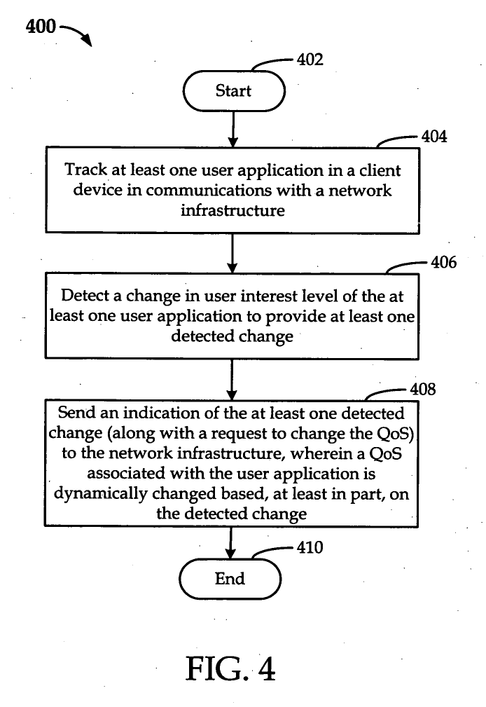

Turning now to FIG. 4, a flow chart diagram of a detection process according to an embodiment of the invention is shown and indicated generally at 400. This process starts 402 with the tracking 404 of at least one user application in a client device that is in communication with a network infrastructure. With the tracking, a change is detected 406 in the user interest level of the at least one user application to provide at least one detected change. Based, at least in part, on this detected change, an indication of the detected change(s) is sent 408, along with an optional request to change to the quality of service according to one specific embodiment, to the network infrastructure. In another embodiment, the indication of the detected change can come in the form of the request to change the quality of service without necessarily including any information about the detected change. The process ends 410 at this point.

Through the embodiments of various teachings, a more intelligent flow priority arrangement has been provided that, among other things, considers the user interest of the client device, instead of following the predefined priority flows of the user applications. As a result, the flow priorities of the user applications match more closely to the current priorities desired by the user instead of the system configurations. This is especially important when the bandwidth resources are limited, such as in the case of wireless network.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
assessing a change in user interest level of a user application of a client device in communication with a network infrastructure at a first quality of service level;
dynamically changing quality of service associated with the user application to a second quality of service level, while keeping the user application active, based, at least in part, on the change in user interest level of the user application.

2. The method according to claim 1 further comprising, prior to assessing a change in user interest level of a user application of a client device in communication with a network infrastructure at a first quality of service level:
initiating the user application at the first quality of service level.

3. The method according to claim 1, wherein assessing a change in user interest level of the user application comprises one or more selected from a group of:
a user specified switch of priority of at least the first user application;
a second application at the client device being initiated;
a triggered mute function in the client device;
a triggered energy conservation function in the client device;
a detection of a user of the client device being away from the client device;
a screensaver being activated;
a backlight being extinguished;
an actuator being triggered in a user chair;
a detection by a camera of a user being away;
an expiration of an inactivity timer;
a short range wireless connection being lost;
a user modification of a numerical priority associated with the user application;
a user adjustment of a slider on a window;
a detection of occluding of a window associated with the user application;
a change in audio volume at the client device;
a triggered download of a web browser plug-in;
a triggered user of a web browser plug-in;
a detection of presence state of at least one user of the client device.

4. The method according to claim 1, wherein dynamically changing quality of service to the client device comprises one or more selected from a group of:
a dedication of resources to a higher priority user activity;
a reduction of resources for a user activity that has been temporarily suspended;
a reduction of resources for a user activity that has been de-prioritized;
a change in data flow priority;
a change in user priority;
a change in an application priority;
a change in latency;
a change in jitter characteristics;
a change in frame erasure rate;
a change in bit error rate;
a change in power control setting;
a change in number of resources assigned to data flow of the user application;
a change in modulation rate;
a change in modulation type;
a change in encoding rate;
a change in speech encoding rate;
a change in video encoding rate;
a change in encoding type;
a change in speech encoding type;
a change in video encoding type.

5. The method according to claim 1, wherein the user application is a video stream such that the first quality of service level is associated with video portion of the video stream and the second quality of service level is associated with the audio portion of the video stream.

6. The method according to claim 1 further comprising:
dynamically changing quality of service associated with a second user application based, at least in part, on the change in user interest level of the user application.

7. The method according to claim 1 further comprising:
dynamically changing quality of service of another user in communication with the network infrastructure based, at least in part, on the change in user interest level of the user application.

8. The method according to claim 1 further comprising:
dynamically changing quality of service of another user in direct communication with a user of the user application based, at least in part, on the change in user interest level of the user application.

9. The method according to claim 1, wherein the first quality of service level is provided from the client device to the network infrastructure via a first quality of service profile identifier.

10. The method according to claim 9, wherein the second quality of service level is provided from the client device to the network infrastructure via a second quality of service profile identifier.

11. A method comprising:
tracking at least one user application in a client device communicating through a network infrastructure;
detecting a change in user interest level of the at least one user application to provide at least one detected change;
sending an indication of the at least one detected change to the network infrastructure, wherein a quality of service associated with the at least one user application is dynamically changed based, at least in part, on the at least one detected change.

12. The method according to claim 11, wherein the at least one detected change comprises one or more selected from a group of:
a user specified switch of priority of at least the first user application;
a second application at the client device being initiated;
a triggered mute function in the client device;
a triggered energy conservation function in the client device;
a detection of a user of the client device being away from the client device;
a screensaver being activated;
a backlight being extinguished;
an actuator being triggered in a user chair;
a detection by a camera of a user being away;
an expiration of an inactivity timer;
a short range wireless connection being lost;
a user modification of a numerical priority associated with the user application;
a user adjustment of a slider on a window;
a detection of occluding of a window associated with the user application;
a change in audio volume at the client device;
a triggered download of a web browser plug-in;
a triggered user of a web browser plug-in;
a detection of presence state of at least one user of the client device.

13. The method according to claim 11, wherein the quality of service associated with the at least one user application is dynamically changed comprises one or more selected from a group of:
a dedication of resources to a higher priority user activity;
a reduction of resources for a user activity that has been temporarily suspended;
a reduction of resources for a user activity that has been de-prioritized;
a change in data flow priority;
a change in user priority;
a change in an application priority;
a change in latency;
a change in jitter characteristics;
a change in frame erasure rate;
a change in bit error rate;
a change in power control setting;
a change in number of resources assigned to data flow of the user application;
a change in modulation rate;
a change in modulation type;
a change in encoding rate;
a change in speech encoding rate;
a change in video encoding rate;
a change in encoding type;
a change in speech encoding type;
a change in video encoding type.

14. The method according to claim 11, wherein the indication further comprises a request to change a current quality of service of the at least one user application based, at least in part, on the at least one detected change.

15. An apparatus comprising:
a controller circuit that tracks at least one user application in a client device communicating through a network infrastructure and detects a change in user interest level of the at least one user application to provide at least one detected change;
a transceiver coupled to the controller circuit that sends an indication of the at least one detected change to the network infrastructure, wherein a quality of service associated with the at least one user application is dynamically changed based, at least in part, on the at least one detected change.

16. The apparatus according to claim 15, wherein the at least one detected change comprises one or more selected from a group of:
a user specified switch of priority of at least the first user application;
a second application at the client device being initiated;
a triggered mute function in the client device;
a triggered energy conservation function in the client device;
a detection of a user of the client device being away from the client device;
a screensaver being activated;
a backlight being extinguished;
an actuator being triggered in a user chair;
a detection by a camera of a user being away;
an expiration of an inactivity timer;
a short range wireless connection being lost;
a user modification of a numerical priority associated with the user application;
a user adjustment of a slider on a window;
a detection of occluding of a window associated with the user application;
a change in audio volume at the client device;
a triggered download of a web browser plug-in;
a triggered user of a web browser plug-in;
a detection of presence state of at least one user of the client device.

17. The apparatus according to claim 15, wherein the quality of service associated with the at least one user application is dynamically changed comprises one or more selected from a group of:
a dedication of resources to a higher priority user activity;
a reduction of resources for a user activity that has been temporarily suspended;
a reduction of resources for a user activity that has been de-prioritized;
a change in data flow priority;
a change in user priority;
a change in an application priority;
a change in latency;
a change in jitter characteristics;
a change in frame erasure rate;
a change in bit error rate;
a change in power control setting;
a change in number of resources assigned to data flow of the user application;
a change in modulation rate;
a change in modulation type;
a change in encoding rate;
a change in speech encoding rate;
a change in video encoding rate;
a change in encoding type;
a change in speech encoding type;
a change in video encoding type.

18. The apparatus according to claim 15, wherein the controller circuit further sends a request to change a current quality of service based, at least in part, on the at least one detected change.

19. A computer-readable medium having thereon computer-executable instructions for:
tracking at least one user application in a client device communicating through a network infrastructure;
detecting a change in user interest level of the at least one user application to provide at least one detected change;
sending an indication of the at least one detected change to the network infrastructure, wherein a quality of service associated with the at least one user application is dynamically changed based, at least in part, on the at least one detected change.
